(19) United States
(12) Patent Application Publication
(10) Pub. No.: US 2022/0215421 A1
(43) Pub. Date: Jul. 7, 2022

(54) ORDERING METHOD AND SYSTEM SUPPORTING COUPON VERIFICATION INTEGRATION

(71) Applicant: KOUBEI (SHANGHAI) INFORMATION TECHNOLOGY CO., LTD., Shanghai (CN)

(72) Inventors: Jingjing SHEN, Shanghai (CN); Li CHEN, Shanghai (CN); Jianqiong ZHUANG, Shanghai (CN)

(21) Appl. No.: 17/601,695

(22) PCT Filed: Mar. 31, 2020
(86) PCT No.: PCT/CN2020/082508

§ 371 Date: Dec. 6, 2021

(30) Foreign Application Priority Data
Apr. 9, 2019 (CN) 201910280778.5

(51) Int. Cl. G06Q 30/02; G06Q 30/06; G06Q 20/38

(52) U.S. Cl. CPC G06Q 30/0239; G06Q 20/387; G06Q 30/0637

(57) ABSTRACT

An ordering method and an ordering system supporting integration of coupon cancellation after verification are disclosed in this application, wherein the method includes: receiving an ordering request initiated by a user for a store; retrieving coupon information of at least one coupon received by the user from the store, wherein the coupon information contains at least one product identifier and product deduction information; adding at least one product corresponding to the coupon information to a to-be-paid product list, determining a to-be-paid amount for products in the to-be-paid product list according to the product deduction information; in response to receiving a payment request initiated by the user, completing payment and coupon cancellation after verification according to the to-be-paid amount for products in the to-be-paid product list.

### CROSS-REFERENCE TO RELATED APPLICATIONS

The present disclosure is a 371 application of PCT International Application No. PCT/CN2020/082508, filed Mar. 31, 2020, which claims priority to Chinese Patent Application No. 2019102807785, filed on Apr. 9, 2019, the entire contents of which are incorporated herein by reference.

### TECHNICAL FIELD

The present disclosure relates to the technical field of data processing, and more particularly, to an ordering method and an ordering system supporting integration of coupon cancellation after verification.

### BACKGROUND

With the development of mobile Internet and e-commerce technology, online transactions are becoming more and more popular. For promotion and advertisement, merchants issue preferential coupons or deduction coupons and other product coupons online for users to receive or purchase. When a user makes purchase offline, the user can present received coupons to the merchant for coupon cancellation after verification.

The current cancellation after verification method includes separation of payment and cancellation after verification, and integration of payment and cancellation after verification. For example, in the separation of payment and cancellation after verification method, a merchant uses a handheld checkout device to obtain information on a coupon received by a user for performing coupon cancellation after verification, after which an order can be placed and corresponding product or service can be provided. In the integration of payment and cancellation after verification method, a merchant enters product information corresponding to the coupon, obtains order information of the user, and according to an actual payment amount calculated based on the order information of the user and deduction information of the coupon, the payment of the actual amount is completed along with the coupon cancellation after verification.

However, in the process of implementing the present disclosure, the inventor found that the related art has at least the following shortcomings: in the separation of payment and cancellation after verification method, both placing an order for products corresponding to a coupon and performing cancellation after verification of the coupon are separated from the ordering process; while in the integration of payment and cancellation after verification method, deduction and coupon cancellation after verification are completed during payment according to the order information of the user, neither of the two methods can support placing order for products corresponding to a coupon and performing coupon cancellation after verification during an online ordering process. On the other hand, the online ordering process aims to simplify ordering process and reduce manual participation. Simply speaking, the online ordering process includes: after entering the online ordering mode, the user selecting a product; and then completing payment. The above two cancellation after verification methods will destroy the integrity of the online ordering process, since the cancellation after verification of the coupons held by the user requires manual operation, which increases the workload of the merchant and causes inconvenience for the user. Moreover, manual operation cannot be guaranteed to be accurate and may cause financial loss and information loss.

### SUMMARY

In view of the above-mentioned problems, the present disclosure is provided to provide an ordering method and an ordering system supporting integration of coupon cancellation after verification, which can overcome the above-mentioned problems or at least partially solve the above-mentioned problems.

According to one aspect of the present disclosure, an ordering method supporting integration of coupon cancellation after verification is provided, including: receiving an ordering request initiated by a user for a store; retrieving coupon information of at least one coupon received by the user from the store, wherein the coupon information contains at least one product identifier and product deduction information; adding at least one product corresponding to the coupon information to a to-be-paid product list, determining a to-be-paid amount for products in the to-be-paid product list according to the product deduction information; in response to receiving a payment request initiated by the user, completing payment and coupon cancellation after verification according to the to-be-paid amount for products in the to-be-paid product list.

According to another aspect of the present disclosure, an ordering method supporting integration of coupon cancellation after verification is provided, including: a receiving module adapted to receive an ordering request initiated by a user for a store; and receive a payment request initiated by the user; a retrieving module adapted to retrieve coupon information of at least one coupon received by the user from the store, wherein the coupon information contains at least one product identifier and product deduction information; a product adding module adapted to add at least one product corresponding to the coupon information to a to-be-paid product list; a to-be-paid amount determining module adapted to determine a to-be-paid amount for products in the to-be-paid product list according to the product deduction information; and a payment and cancelling after verifying module adapted to complete payment and coupon cancellation after verification according to the to-be-paid amount for products in the to-be-paid product list.

According to still another aspect of the present disclosure, a computing device is provided, including: a processor, a memory, a communication interface, and a communication bus, wherein the processor, the memory, and the communication interface communicate with each other through the communication bus; the memory is configured to store at least one executable instruction, and the executable instruction causes the processor to perform operations corresponding to the ordering method supporting integration of coupon cancellation after verification described above.

According to yet still another aspect of the present disclosure, a non-volatile computer-readable storage medium is provided, the on-volatile computer-readable storage medium has at least one executable instruction stored therein, and the executable instruction causes a processor to perform operations corresponding to the ordering method supporting integration of coupon cancellation after verification described above.

According to yet still another aspect of the present disclosure, a computer program product is provided, wherein the computer program product includes a computer program stored on a non-volatile computer storage medium.

According to the ordering method and the ordering system supporting integration of coupon cancellation after verification provided in the present disclosure, the method includes: receiving an ordering request initiated by a user for a store; retrieving coupon information of at least one coupon received by the user from the store, where the coupon information contains at least one product identifier and product deduction information; adding at least one product corresponding to the coupon information to a to-be-paid product list, determining a to-be-paid amount for products in the to-be-paid product list according to the product deduction information; in response to receiving a payment request initiated by the user, completing payment and coupon cancellation after verification according to the to-be-paid amount for products in the to-be-paid product list. In the method, by adding the at least product corresponding to the coupon in the ordering process, both the payment of the order and the coupon cancellation after verification can be completed in an order settle stage. It can realize the function of including coupon cancellation after verification in the ordering process, making the ordering process simpler, further reducing human labor and improving efficiency. The entire ordering process can be completed online, which can ensure the integrity of the information flow.

The above description is only an overview of the technical solutions of the present disclosure. In order to more clearly understand the technical means of the present disclosure, which can be implemented in accordance with the content of the specification, and in order to make the above and other objectives, features and advantages of the present disclosure more apparent and understandable, specific embodiments of the present disclosure will be illustrated in the following.

### BRIEF DESCRIPTION OF THE DRAWINGS

By reading the detailed description of the preferred embodiments below, various other advantages and benefits will become apparent to those of ordinary skill in the art. The drawings are only used for the purpose of illustrating the preferred embodiments, and are not considered as a limitation to the present disclosure. Also, throughout the drawings, like reference symbols are used to denote like components. In the accompanying drawings:

FIG. 1 shows a schematic flowchart of an ordering method supporting integration of coupon cancellation after verification according to an embodiment of the present disclosure;

FIG. 2 shows a schematic flowchart of an ordering method supporting integration of coupon cancellation after verification according to another embodiment of the present disclosure;

FIG. 3 shows a schematic structural diagram of an ordering system supporting integration of coupon cancellation after verification according to another embodiment of the present disclosure;

FIG. 4 shows a schematic structural diagram of a computing device according to an embodiment of the present disclosure.

### DETAILED DESCRIPTION OF THE EMBODIMENTS

Exemplary embodiments of the present disclosure will be described in more detail below with reference to the accompanying drawings. Although the drawings show the exemplary embodiments of the present disclosure, it should be understood that the present disclosure can be implemented in various forms and should not be limited by the embodiments set forth herein. Rather, these embodiments are provided to enable a more thorough understanding of the present disclosure and to fully convey the scope of the present disclosure to those skilled in the art.

Take a catering store as an example. If the store wants to implement online ordering, it needs to transform the service flow in the store. In a conventional ordering process, users can pay first or pay later. The following describes ordering processes under a pre-payment mode and a post-payment mode.

(1) Pre-Payment

An existing ordering process under the pre-payment mode is as follows. A user orders a meal at a cashier and make payment, and then takes a meal-receiving number to his/her seat. At the background, the merchant receives a corresponding relationship between meal and meal-receiving number. After the meal is ready, the user picks it up from the dining room or a waiter delivers the meal to the seat. Here, in the existing process, a product coupon is subjected to cancellation after verification independently (separation of payment and cancellation after verification), or the product coupon is subjected to cancellation after verification during payment, and the product corresponding to the coupon is added to the current food list (integration of payment and cancellation after verification).

A transformed ordering process based on the existing ordering process under the pre-payment mode is as follows. After the user has a seat, the user scans a table code of the store or clicks an ordering button in the store to enter the ordering mode of the store. The user orders a meal and completes payment online, and obtains a meal-receiving number or a dish associated with the number of the table. After the meal is ready, the user picks the meal from the dining room or the waiter delivers the meal to the table. The user enjoys the meal and leaves the store.

(2) Post-Payment

An existing ordering process under the post-payment mode is as follows. After the user has a seat, the waiter arrives at the table to assist the user in ordering. When completed, the waiter records dishes according to the table number in a system and places the order. After the meal is ready, the waiter delivers the meal to the table, and the user enjoys the meal, makes payment and leaves the store. Here, in the existing process, the product coupon is subjected to cancellation after verification when the waiter assists the user in ordering, and the waiter manually records the dishes corresponding to the coupon and places an order according to the table number.

A transformed ordering process based on the existing ordering process under the post-payment mode is as follows. After the user has a seat, the user scans a table code of the store or clicks an ordering button in the store to enter the ordering mode of the store. The user orders a meal, and dishes of the meal are associated with the table. After the meal is ready, the user picks the meal from the dining room or the waiter delivers the meal to the table. The user enjoys the meal and leaves the store.

It can be seen that, during the transformed ordering process, the user has no opportunity to interact with the waiter before placing the order and communicate the coupon information to the waiter. Therefore, once the store completes the online ordering transformation, it will affect the merchant's positivity to use coupons for attracting clients, and the coupons will also add extra workload to the store, which is contrary to the purpose of reducing staff and increasing efficiency of online ordering. In addition, the ordering process is separated from ordering the product corresponding to the coupon and performing coupon cancellation after verification process accordingly, which requires manual operations, interrupts the integrity of the information flow, and may cause financial loss and information loss. Based on this, the present disclosure provides a solution suitable for supporting integration of coupon cancellation after verification in the ordering process after the transformation.

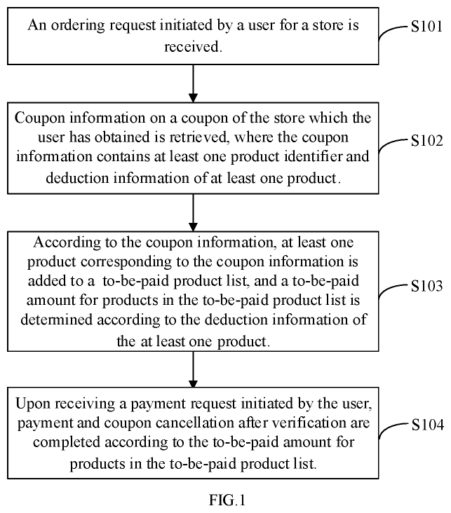

FIG. 1 shows a schematic flowchart of an ordering method supporting integration of coupon cancellation after verification according to an embodiment of the present disclosure. As shown in FIG. 1, the method includes the following steps.

In step S101, an ordering request initiated by a user for a store is received.

Here, the user uses a client to scan a table code of the store to initiate an ordering request for the store and enters the ordering mode of the store; or the user clicks the ordering button of the store displayed in the client to initiate an ordering request and enters the ordering mode of the store. Here, the client may be an application installed on the user's smart phone, such as a life-type APP that can provide online food ordering services, for example, Koubei APP, Alipay APP, etc. The above two methods for the user to initiate an ordering request are merely optional implementations of the present disclosure, and the present disclosure does not limit the methods for the user to initiate an ordering request.

In step S102, coupon information of at least one coupon received by the user from the store is retrieved, where the coupon information contains at least one product identifier and product deduction information.

When receiving the ordering request initiated by the user for the store, coupon information of at least one coupon received by the user from the store is automatically retrieved. Here, the coupon information may involve a deduction coupon that the user has purchased, for example, a deduction coupon of 80-yuan-for-90-yuan for a Fried-Chicken-Combo-for-two package, and the coupon information on the deduction coupon includes: product identifier of each food product contained in a Fried-Chicken-Combo-for-two package, and deduction information of 80 Yuan for 90 Yuan. Such coupon is generally bought by the user for a certain of money. The coupon information can also involve a preferential coupon received by a user, for example, a discount coupon or a rebate coupon applicable to a corresponding store, such as a rebating-20-yuan-for-100-yuan-paid coupon, the coupon information on the preferential coupon includes deduction information of rebating 20 Yuan for 100 Yuan paid. Such preferential coupons can be obtained by the user receiving them without paying any amount. However, this is only an example and does not have any limiting effect on the present disclosure.

In step S103, at least one product corresponding to the coupon information is added to a to-be-paid product list, and a to-be-paid amount for products in the to-be-paid product list is determined according to the product deduction information.

According to the at least one product identifier contained in the coupon information retrieved, at least one product (referred to as coupon product hereinafter) corresponding to the coupon information is added to the to-be-paid product list, that is, at least one coupon product is added to a shopping cart; according to the product deduction information contained in the retrieved coupon information, the to-be-paid amount for products in the to-be-paid product list is determined, that is, the to-be-paid amount for products in the shopping cart is calculated. For example, if the retrieved coupon information indicates that the user has purchased the deduction coupon of 80-yuan-for-90-yuan for a Fried-Chicken-Combo-for-two package, the each food product contained in the Fried-Chicken-Combo-for-two package is added to the to-be-paid product list, and since the deduction coupon has been purchased by the user in advance, the to-be-paid amount for products in the to-be-paid product list is determined as 0 Yuan.

In step S104, in response to receiving a payment request initiated by the user, payment and coupon cancellation after verification are completed according to the to-be-paid amount for products in the to-be-paid product list.

For example, the user can click the payment button displayed in the client to initiate a payment request. In response to receiving the payment request initiated by the user, the user's account will be debited according to the to-be-paid amount for products in the to-be-paid product list, and the coupon corresponding to the at least one coupon product in the to-be-paid product list will be subjected to cancellation after verification. In the above example, when the user initiates a payment request, the deduction coupon of 80-yuan-for-90-yuan for a Fried-Chicken-Combo-for-two package is subjected to cancellation after verification, and since the to-be-paid amount is 0 yuan, the user's account will not be debited.

There are currently online ordering solutions. For example, the client scans the table code to enter the ordering page of the store, the user orders the meal on the ordering page, and finally confirms the order and makes the payment. The user can complete the ordering process by himself. However, if the user holds a meal deduction coupon of a store, provides the coupon information to the merchant, the merchant will manually place an order for the meal corresponding to the coupon and completes the cancellation after verification of the coupon; or when the user holds a cash coupon of a store, when the cash coupon is provided to the merchant at the time of settlement, the merchant will use the corresponding device to calculate the actual payment amount based on the deduction information of the cash coupon and the order information of the user, and perform cancellation after verification on the cash coupon. Thus, existing coupon cancellation after verification schemes all require the assistance of merchants. For users, it is not possible to complete the ordering process completely by themselves. For merchants, additional manpower is also required to complete the coupon cancellation after verification.

It can be seen that, compared with the related art, this method obtains coupon information of at least one coupon received by the user, adds at least one product corresponding to the coupon information to the shopping cart to place an order, and when the order is paid, it can also perform cancellation after verification on the coupon corresponding to the at least one coupon product in the shopping cart, which can realize the function of integrating coupon cancellation after verification into the online ordering process. The entire process can be performed online. Both of placing an order of coupon products and coupon cancellation after verification can be done without merchant assistance, which can save labor costs and improve efficiency, avoid manual error operations, ensure the integrity and security of the information flow, and truly realize self-service online ordering.

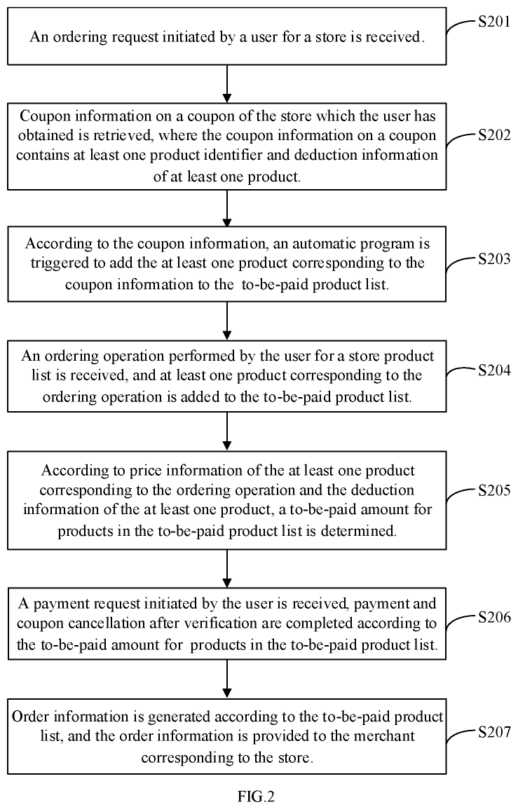

FIG. 2 shows a schematic flowchart of an ordering method supporting integration of coupon cancellation after verification according to another embodiment of the present disclosure. In this embodiment, a meal ordering scene is taken as an example for description. However, the application scenario of the present disclosure is not limited. Here, as shown in FIG. 2, the method includes the following steps.

In step S201, an ordering request initiated by a user for a store is received.

Here, the user uses a client to scan a table code of the store to initiate an ordering request for the store and enters the ordering mode of the store; or the user clicks the ordering button of the store displayed in the client to initiate an ordering request and enters the ordering mode of the store. Here, the client may be an application installed on the user's smart phone, such as a life-type APP that can provide online food ordering services, for example, Koubei APP, Alipay APP, etc. The above two methods for the user to initiate an ordering request are merely optional implementations of the present disclosure, and the present disclosure does not limit the methods for the user to initiate an ordering request.

In step S202, coupon information of at least one coupon received by the user from the store is retrieved, where the coupon information contains at least one product identifier and product deduction information.

When receiving the ordering request initiated by the user for the store, coupon information of at least one coupon received by the user from the store is automatically retrieved. Here, the coupon information may involve a deduction coupon that the user has purchased, for example, coupon information on a deduction coupon of 80-yuan-for-90-yuan for a Fried-Chicken-Combo-for-two package. Such coupon is generally bought by a user for a certain of money. The product identifiers contained in the coupon information on the deduction coupon are specifically product identifiers of respective food products contained in the Fried-Chicken-Combo-for-two package, and the deduction information contained in the coupon information is information of 80 Yuan for 90 Yuan. The coupon information can also involve a cash coupon which has been purchased by the user, for example, a cash coupon of 90-yuan-for-100-yuan. Such coupon is generally obtained by a user through purchase. The product identifier contained in the coupon information on the cash coupon is specifically an identifier of the cash coupon, and the deduction information is information of 90 Yuan for 100 Yuan. The coupon information can also involve a preferential coupon received by a user. Such preferential coupons can be obtained by receiving them by the user without paying any amount, for example, discount coupons or rebate coupons applicable to a corresponding store, such as a rebating-20-yuan-for-100-yuan-paid coupon, with the production identifier contained in the coupon information on such a preferential coupon can be an identifier of the preferential coupon, and the deduction information is rebating 20 Yuan for 100 Yuan paid.

In addition, in an implementation, a coupon information retrieving request initiated by the user can also be received, and the coupon information of at least one coupon received by the user from the store is retrieved according to the coupon information retrieving request, that is, the user actively retrieves the coupon that he has obtained. However, this is only an example, and the solution of the present disclosure is not limited to this.

In step S203, an automatic program is triggered to add at least one product corresponding to the coupon information to the to-be-paid product list.

After retrieving the coupon information of at least one coupon received by the user from the store, an automatic program is triggered to automatically add at least one product corresponding to the coupon information to the to-be-paid product list.

For example, for the abovementioned deduction coupon of 80-yuan-for-90-yuan for a Fried-Chicken-Combo-for-two package, the coupon information on the deduction coupon contains identifiers of respective food products contained in the Fried-Chicken-Combo-for-two package, the respective food products contained in the Fried-Chicken-Combo-for-two package are automatically added to the to-be-paid product list. For the cash coupon of 90 Yuan for 100 Yuan, according to the coupon information on the cash coupon, the cash coupon is added to the to-be-paid product list. For the rebate coupon of rebating-20-yuan-for-100-yuan-paid, according to the coupon information on the rebate information, the rebate coupon is added to the to-be-paid product list.

The above method automatically adds at least one product corresponding to the coupon information to the to-be-paid product list after retrieving the coupon information of at least one coupon received by the user from the store. In addition, according to the user's selection operation, at least one product corresponding to the coupon information selected by the user can be added to the to-be-paid product list.

Specifically, after retrieving the coupon information of at least one coupon received by the user from the store, the retrieved coupon information of at least one coupon received by the user from the store is displayed; the selection operation performed by the user for the coupon information is received, and at least one product corresponding to the coupon information according to the selection operation is added to the to-be-paid product list. The retrieved coupon information of at least one coupon received by the user from the store is sent to the client for display, the user selects from the coupon information displayed in the client, and according to the selection operation performed by the user, at least one product corresponding to the coupon information selected by the user is added to the to-be-paid product list.

In addition, the to-be-paid product list is also editable, and the user can perform operations on the to-be-paid product list to reduce a number of products, and can also perform operations on the to-be-paid product list to increase the number of products. Specifically, the to-be-paid product list is displayed, the user's delete operation performed on the products in the to-be-paid product list is received, and the number of products targeted by the delete operation is modified according to the delete operation; the user's increase operation performed on the products in the to-be-paid product list is received, and the number of products targeted by the increase operation is modified according to the increase operation. For example, the retrieved coupon information involves two detection coupons of 80-yuan-for-90-yuan for a Fried-Chicken-Combo-for-two package, the two detection coupons are automatically added to the to-be-paid product list. Since the user can only use one deduction coupon this time, the user can click a “minus 1” button corresponding to the deduction coupon. At this time, the to-be-paid product list only contains food products contained in one Fried-Chicken-Combo-for-two package in the to-be-paid product list. Similarly, the “plus 1” button corresponding to the product can be clicked to increase the number of the product by 1, which will not be elaborated. However, the solution of the present disclosure is not limited to this.

In step S204, an ordering operation performed by the user for a store product list is received, and at least one product corresponding to the ordering operation is added to the to-be-paid product list.

After the user initiates an ordering request, the store ordering mode is entered, and the client displays the store product list for the user to select. The user performs an ordering operation on the store product list, such as clicking an ordering button corresponding to a product displayed in the client, to add the product to the to-be-paid product list.

In step S205, according to product price information corresponding to the ordering operation and the product deduction information, a to-be-paid amount for products in the to-be-paid product list is determined.

After step S204, the to-be-paid product list includes products selected by the user and at least one product corresponding to the user received coupon. The actual payment amount is determined according to the price of each product selected by the user and the deduction information of the coupon. For example, the products included in the current to-be-paid product list are shown in Table 1.

Here, the preferential meal is an 80-yuan-for-90-yuan for a Fried-Chicken-Combo-for-two package, the user has purchased the coupon in advance, and when ordering at the store, according to the product identifiers contained in the coupon information on the deduction coupon, the products (i.e. the classic Korean bibimbap, spicy chicken wings, crispy boneless chicken nuggets, and thick French fries in Table 1) corresponding to the product identifiers are added to the to-be-paid product list. In addition, the user also selects sweet and spicy chicken wings from the store product list and add them to the to-be-paid product list. Then, because the user has already paid for the deduction coupon, the amount corresponding to the preferential meal presented in the to-be-paid product list is 0 Yuan, and the user only needs to pay the price of 22 Yuan for the sweet and spicy chicken wings that he ordered, that is, the to-be-paid amount for the products in the to-be-paid product list is 22 Yuan.

TABLE 1

| | | | Price | |
|---|---|---|---|---|
| | | | per | |
| Items | Food products | Number | Unit | Amount |
| preferential meal | classic Korean | 2 | 25 | 0 |
| | bibimbap | | | |
| | spicy chicken wings | 2 | 6 | |
| | crispy boneless | 2 | 8 | |
| | chicken nuggets | | | |
| | thick French fries | 1 | 12 | |
| ordering | sweet and spicy | 2 | 11 | 22 |
| | chicken wings | | | |

| | |
|---|---|
| to-be-paid amount | 22 |

Also taking the cash coupon of 90-yuan-for-100-yuan as an example, the user has purchased the coupon in advance and added the cash coupon to the to-be-paid product list when ordering at the store. At this time, it is assumed that each food product in the Table 1 is selected by the user. In this case, the to-be-paid amount is calculated according to the cash coupon and the total price of the food products manually selected by the user, that is, the total price of the meal minus 100 Yuan.

In step S206, in response to a payment request initiated by the user is received, payment and coupon cancellation after verification are completed according to the to-be-paid amount for products in the to-be-paid product list.

Optionally, after the payment is completed according to the to-be-paid amount in the to-be-paid product list, the coupon corresponding to the products in the to-be-paid product list is subjected to cancellation after verification.

For example, the user can click the payment button displayed in the client to initiate a payment request. In response to receiving the payment request initiated by the user, the user's account will be debited according to the to-be-paid amount for products in the to-be-paid product list, and the coupon corresponding to the products in the to-be-paid product list is subjected to cancellation after verification. In the above example, when the user initiates a payment request, 22 Yuan is debited from the user's account, and the user received deduction coupon of 80-yuan-for-90-yuan for a Fried-Chicken-Combo-for-two package is subjected to cancellation after verification. Similarly, in the above scenario of cash coupons, when a user initiates a payment request, the corresponding amount is debited from the user's account according to the to-be-paid amount, and the user received cash coupon of 90-yuan-for-100-yuan is subjected to cancellation after verification.

It can be seen that using this method, at least one coupon product and the product selected by the user can be combined to place an order, and the payment can be completed at the same time as the coupon cancellation after verification. The ordering process does not require the participation of merchants, and the entire operation can be performed online, and the information flow of a single process is integrity.

In the payment link, the user can also scan the code to make payment. Specifically, in response to an order confirmation request initiated by the user is received, code information carrying the to-be-paid amount for products in the to-be-paid product list is generated; in response to a payment request initiated by the user scanning the code information is received, payment and coupon cancellation after verification are completed according to the to-be-paid amount for products in the to-be-paid product list.

When the user confirms that the to-be-paid product list is correct, he can click a confirming order button displayed in the client to initiate an order confirmation request. In response to receiving a user-initiated order confirmation request, according to the to-be-paid amount products in the to-be-paid product list of the user, code information is generated; the user uses the client to scan the code information to initiate a payment request, and in response to receiving the payment request initiated by the user scanning the code information, the user's account is debited while the coupon cancellation after verification is completed. The code information may refer to code information composed of image recognition elements in accordance with specific coding rules, such as a two-dimensional code, a three-dimensional code, and a barcode, which is not limited in the present disclosure.

In step S207, order information is generated according to the to-be-paid product list, and the order information is provided to the merchant corresponding to the store.

The order information is generated according to the to-be-paid product list, and the order information is provided to the corresponding store terminal of the store for the merchant to prepare the products according to the order information. For example, in a catering scenario, the merchant prepares meals according to the order.

Here, step S206 is performed before step S207 which corresponds to the ordering process of the pre-payment mode, that is, the user pays first, and successful payment indicates that the user confirms the order. After the payment is successful, order information is generated and provided to the merchant for meal preparation.

Step S207 can also be performed before step S206, which corresponds to the ordering process of the post-payment mode. That is, when the user confirms the to-be-paid product list, an order confirmation request is initiated first, and at this time order information is generated according to the to-be-paid product list, and is provided to the merchant to prepare meal. The user initiates a payment request after confirming the order. In the ordering process of the post-payment mode, the user can conduct the payment by scanning code. For example, in response to receiving an order confirmation request initiated by the user, order information can be generated and provided to the corresponding merchant in the store for ordering. At the same time, code information carrying the to-be-paid amount for products in the to-be-paid product list is generated, the code information is printed in the form of a small ticket, and the user conducts the payment by scanning the code information.

Accordingly, in this method, by obtaining coupon information of a coupon received by the user, it is possible to add at least one product corresponding to the coupon information to a shopping cart, also add the products selected by the user to the shopping cart, and place an order in a combination of the coupon products with the products manually selected by the user. The payment can be performed at the same time as the coupon cancellation after verification. The entire ordering process can be operated online throughout the entire ordering process, without the need for merchants to assist in the placement and cancellation after verification of coupons, saving labor costs and improving efficiency in ordering, ensuring the integrity and security of the information flow, and truly realizing online ordering.

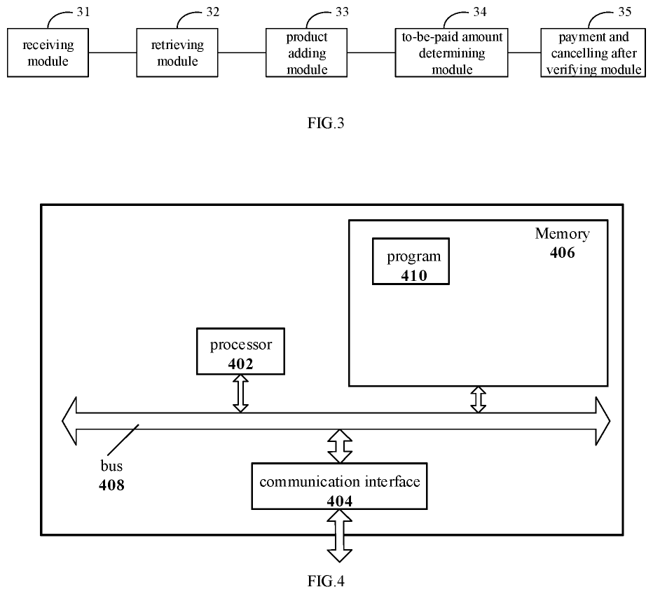

FIG. 3 shows a schematic structural diagram of an ordering system supporting integration of coupon cancellation after verification according to another embodiment of the present disclosure. As shown in FIG. 3, the system includes:

a receiving module 31 adapted to receive an ordering request initiated by a user for a store; and receive a payment request initiated by the user;

a retrieving module 32 adapted to retrieve coupon information of at least one coupon received by the user from the store, where the coupon information contains at least one product identifier and product deduction information;

a product adding module 33 adapted to add at least one product corresponding to the coupon information to a to-be-paid product list;

a to-be-paid amount determining module 34 adapted to determine a to-be-paid amount for products in the to-be-paid product list according to the product deduction information;

a payment and cancelling after verifying module 35 adapted to complete payment and coupon cancellation after verification according to the to-be-paid amount for products in the to-be-paid product list.

Optionally, the receiving module 31 is further adapted to receive an ordering operation performed by the user for a store product list.

Then the product adding module 33 is further adapted to add at least one product corresponding to the ordering operation to the to-be-paid product list.

Then the to-be-paid amount determining module 34 is further adapted to determine a to-be-paid amount for products in the to-be-paid product list according to product price information corresponding to the ordering operation and the product deduction information.

Optionally, the system further includes:

a displaying module adapted to display the retrieved coupon information of at least one coupon received by the user from the store.

Then the receiving module 31 is further adapted to receive a selection operation performed by the user for the coupon information.

The product adding module 33 is further adapted to add at least one product corresponding to the coupon information according to the selection operation to the to-be-paid product list.

Optionally, the product adding module 33 is further adapted to trigger an automatic program to add at least one product corresponding to the coupon information to the to-be-paid product list.

An embodiment of the present disclosure provides a non-volatile computer-readable storage medium, the non-volatile computer-readable storage medium stores at least one executable instruction, and the computer-executable instruction can execute the ordering method supporting integration of coupon cancellation after verification in any of the foregoing method embodiments.

FIG. 4 shows a schematic structural diagram of a computing device according to an embodiment of the present disclosure, and the specific embodiment of the present disclosure does not limit the specific implementation of the computing device.

As shown in FIG. 4, the computing device may include a processor 402, a communication interface 404, a memory 406, and a communication bus 408.

wherein:

the processor 402, the communication interface 404, and the memory 406 communicate with each other through the communication bus 408.

The communication interface 404 is configured to communicate with other devices such as network elements of clients, other servers or the like.

The processor 402 is configured to execute a program 410, and specifically can execute the relevant steps in the embodiment of the ordering method supporting integration of coupon cancellation after verification.

Specifically, the program 410 may include program code, and the program code includes computer operation instructions.

The processor 402 may be a Central Processing Unit CPU, or an Application Specific Integrated Circuit (ASIC), or one or more integrated circuits configured to implement the embodiments of the present disclosure. The one or more processors included in the computing device may be the same type of processors, such as one or more CPUs, or different types of processors, such as one or more CPUs and one or more ASICs.

The memory 406 is configured to store the program 410. The memory 406 may include a high-speed RAM memory, and may also include a non-volatile memory, for example, at least one magnetic disk memory.

The program 410 may be specifically configured to cause the processor 402 to perform the ordering method supporting integration of coupon cancellation after verification in any of the above method embodiments. For the specific implementation of each step in the program 410, reference may be made to the corresponding description in the corresponding steps and units in the above-mentioned embodiment of the ordering method supporting integration of coupon cancellation after verification, which will not be repeated here. Those skilled in the art can clearly understand that, for convenience and concise description, the specific working process of the devices and modules described above can be referred to the corresponding process description in the foregoing method embodiment, which will not be repeated here.

The algorithms and displays provided here are not inherently related to any particular computer, virtual system or other equipment. Various general-purpose systems can also be used with the teaching based on the teachings herein. Based on the above description, the structure required to construct this type of system is apparent. In addition, the present disclosure is not directed to any specific programming language. It should be understood that various programming languages can be used to implement the content of the present disclosure described herein, and the above description of a specific language is for the purpose of disclosing the best embodiment of the present disclosure.

In the specification provided here, a lot of specific details are explained. However, it can be understood that the embodiments of the present disclosure may be practiced without these specific details. In some instances, well-known methods, structures, and technologies are not shown in detail, so as not to obscure the understanding of this specification.

Similarly, it should be understood that in order to simplify the present disclosure and help understand one or more of the various disclosed aspects, in the above description of the exemplary embodiments of the present disclosure, the various features of the present disclosure are sometimes grouped together into a single embodiment, figure, or its description. However, the disclosed method should not be interpreted as reflecting the intention that the claimed disclosure requires more features than those explicitly recorded in each claim. More precisely, as reflected in the following claims, the disclosure aspect lies in less than all the features of a single embodiment previously disclosed. Therefore, the claims following the specific embodiment are thus explicitly incorporated into the specific embodiment, wherein each claim itself serves as a separate embodiment of the present disclosure.

Those skilled in the art can understand that it is possible to adaptively change the modules in the device in the embodiment and set them in one or more devices different from the embodiment. The modules or units or components in the embodiments can be combined into one module or unit or component, and in addition, they can be divided into multiple sub-modules or sub-units or sub-components. Except that at least some of such features and/or processes or units are mutually exclusive, any combination can be used to combine all features disclosed in this specification (including the accompanying claims, abstract and drawings) and all the processes or units of any method or device disclosed in this manner. Unless expressly stated otherwise, each feature disclosed in this specification (including the accompanying claims, abstract and drawings) may be replaced by an alternative feature providing the same, equivalent or similar purpose.

In addition, those skilled in the art can understand that although some embodiments described herein include certain features but not other features included in other embodiments, the combination of features in different embodiments means that they are within the scope of the present disclosure and form different embodiments. For example, in the following claims, any one of the claimed embodiments can be used in any combination.

The various component embodiments of the present disclosure may be implemented by hardware, or by software modules running on one or more processors, or by a combination of them. Those skilled in the art should understand that a microprocessor or a digital signal processor (DSP) may be used in practice to implement some or all of the functions of some or all of the components in the computing device according to the embodiments of the present disclosure. The present disclosure can also be implemented as a device or device program (for example, a computer program and a computer program product) for executing part or all of the methods described herein. Such a program for realizing the present disclosure may be stored on a computer-readable medium, or may have the form of one or more signals. Such a signal can be downloaded from an Internet website, or provided on a carrier signal, or provided in any other form.

It should be noted that the above-mentioned embodiments illustrate rather than limit the present disclosure, and those skilled in the art can design alternative embodiments without departing from the scope of the appended claims. In the claims, any reference sign placed between parentheses should not be constructed as a limitation to the claims. The word “comprise” does not exclude the presence of elements or steps not listed in the claims. The word “a” or “an” preceding an element does not exclude the presence of multiple of such elements. The present disclosure can be realized by means of hardware including several different elements and by means of a suitably programmed computer. In the unit claims enumerating several devices, several of these devices may be embodied in the same hardware item. The use of the words “first”, “second”, and “third”, etc. does not indicate any order. These words can be interpreted as names.

What is claimed is:

1. An ordering method supporting integration of coupon cancellation after verification, comprising:
receiving an ordering request initiated by a user for a store;
retrieving coupon information of at least one coupon received by the user from the store, wherein the coupon information contains at least one product identifier and product deduction information;
adding at least one product corresponding to the coupon information to a to-be-paid product list,
determining a to-be-paid amount for products in the to-be-paid product list according to the product deduction information; and
in response to receiving a payment request initiated by the user, completing payment and coupon cancellation after verification according to the to-be-paid amount for products in the to-be-paid product list.

2. The method according to claim 1, wherein
after the receiving an ordering request initiated by a user for a store, the method further comprises:
in response to receiving an ordering operation performed by the user for a store product list, adding at least one product corresponding to the ordering operation to the to-be-paid product list;
the determining a to-be-paid amount for products in the to-be-paid product list according to the product deduction information further comprises:
determining a to-be-paid amount for products in the to-be-paid product list according to product price information corresponding to the ordering operation and the product deduction information.

3. The method according to claim 1, wherein
after the retrieving coupon information of at least one coupon received by the user from the store, the method further comprises:
displaying the retrieved coupon information of at least one coupon received by the user from the store; and
the adding at least one product corresponding to the coupon information to a to-be-paid product list further comprises:
in response to receiving a selection operation performed by the user for the coupon information, adding at least one product corresponding to the coupon information according to the selection operation to the to-be-paid product list.

4. The method according to claim 1, wherein the adding at least product corresponding to the coupon information to a to-be-paid product list further comprises:
triggering an automatic program to add at least one product corresponding to the coupon information to the to-be-paid product list.

5. The method according to claim 1, wherein in response to receiving a payment request initiated by the user, completing payment and coupon cancellation after verification according to the to-be-paid amount for products in the to-be-paid product list further comprises:
in response to receiving an order confirmation request initiated by the user, generating code information carrying the to-be-paid amount for products in the to-be-paid product list;
in response to receiving a payment request initiated by the user scanning the code information, completing payment and coupon cancellation after verification according to the to-be-paid amount for products in the to-be-paid product list.

6. The method according to claim 5, further comprising:
generating order information according to the to-be-paid product list, and
providing the order information to a merchant of the store.

7. (canceled)

8. (canceled)

9. (canceled)

10. (canceled)

11. A computing device, comprising: a processor, a memory, a communication interface, and a communication bus, wherein
the processor, the memory, and the communication interface communicate with each other through the communication bus;
the memory is configured to store at least one executable instruction, and
the executable instruction causes the processor to perform operations comprising:
receiving an ordering request initiated by a user for a store;
retrieving coupon information of at least one coupon received by the user from the store, wherein the coupon information contains at least one product identifier and product deduction information;
adding at least one product corresponding to the coupon information to a to-be-paid product list,
determining a to-be-paid amount for products in the to-be-paid product list according to the product deduction information; and
in response to receiving a payment request initiated by the user, completing payment and coupon cancellation after verification according to the to-be-paid amount for products in the to-be-paid product list.

12. A non-volatile computer-readable storage medium having at least one executable instruction stored in the non-volatile computer-readable storage medium, and the executable instruction causes a processor to perform operations comprising:
receiving an ordering request initiated by a user for a store;
retrieving coupon information of at least one coupon received by the user from the store, wherein the coupon information contains at least one product identifier and product deduction information;
adding at least one product corresponding to the coupon information to a to-be-paid product list,
determining a to-be-paid amount for products in the to-be-paid product list according to the product deduction information; and
in response to receiving a payment request initiated by the user, completing payment and coupon cancellation after verification according to the to-be-paid amount for products in the to-be-paid product list.

13. A computer program product, wherein the computer program product comprises a computer program stored on a non-volatile computer storage medium, the computer program comprises program instructions, and when the program instructions are executed by a processor, causes the processor to perform operations corresponding to the ordering method supporting integration of coupon cancellation after verification according to claim 1.

14. The computing device according to claim 11, wherein
after the receiving an ordering request initiated by a user for a store, the method further comprises:
in response to receiving an ordering operation performed by the user for a store product list, adding at least one product corresponding to the ordering operation to the to-be-paid product list;
the determining a to-be-paid amount for products in the to-be-paid product list according to the product deduction information further comprises:
determining a to-be-paid amount for products in the to-be-paid product list according to product price information corresponding to the ordering operation and the product deduction information.

15. The computing device according to claim 11, wherein
after the retrieving coupon information of at least one coupon received by the user from the store, the method further comprises:
displaying the retrieved coupon information of at least one coupon received by the user from the store; and
the adding at least one product corresponding to the coupon information to a to-be-paid product list further comprises:
in response to receiving a selection operation performed by the user for the coupon information, adding at least one product corresponding to the coupon information according to the selection operation to the to-be-paid product list.

16. The computing device according to claim 11, wherein the adding at least product corresponding to the coupon information to a to-be-paid product list further comprises:
triggering an automatic program to add at least one product corresponding to the coupon information to the to-be-paid product list.

17. The computing device according to claim 11, wherein in response to receiving a payment request initiated by the user, completing payment and coupon cancellation after verification according to the to-be-paid amount for products in the to-be-paid product list further comprises:
in response to receiving an order confirmation request initiated by the user, generating code information carrying the to-be-paid amount for products in the to-be-paid product list;
in response to receiving a payment request initiated by the user scanning the code information, completing payment and coupon cancellation after verification according to the to-be-paid amount for products in the to-be-paid product list.

18. The computing device according to claim 11, wherein the executable instruction further causes the processor to perform operations comprising:
generating order information according to the to-be-paid product list, and
providing the order information to a merchant of the store.

19. The non-volatile computer-readable storage medium according to claim 12, wherein
after the receiving an ordering request initiated by a user for a store, the executable instruction further causes the processor to perform operations comprising:
in response to receiving an ordering operation performed by the user for a store product list, adding at least one product corresponding to the ordering operation to the to-be-paid product list;
the determining a to-be-paid amount for products in the to-be-paid product list according to the product deduction information further comprises:
determining a to-be-paid amount for products in the to-be-paid product list according to product price information corresponding to the ordering operation and the product deduction information.

20. The non-volatile computer-readable storage medium according to claim 12, wherein
after the retrieving coupon information of at least one coupon received by the user from the store, the executable instruction further causes the processor to perform operations comprising:
displaying the retrieved coupon information of at least one coupon received by the user from the store; and
the adding at least one product corresponding to the coupon information to a to-be-paid product list further comprises:
in response to receiving a selection operation performed by the user for the coupon information, adding at least one product corresponding to the coupon information according to the selection operation to the to-be-paid product list.

21. The non-volatile computer-readable storage medium according to claim 12, wherein the adding at least product corresponding to the coupon information to a to-be-paid product list further comprises:
triggering an automatic program to add at least one product corresponding to the coupon information to the to-be-paid product list.

22. The non-volatile computer-readable storage medium according to claim 12, wherein in response to receiving a payment request initiated by the user, completing payment and coupon cancellation after verification according to the to-be-paid amount for products in the to-be-paid product list further comprises:
in response to receiving an order confirmation request initiated by the user, generating code information carrying the to-be-paid amount for products in the to-be-paid product list;
in response to receiving a payment request initiated by the user scanning the code information, completing payment and coupon cancellation after verification according to the to-be-paid amount for products in the to-be-paid product list.

23. The non-volatile computer-readable storage medium according to claim 12, the executable instruction further causes the processor to perform operations comprising:
generating order information according to the to-be-paid product list, and
providing the order information to a merchant of the store.
